(19) United States
(12) Patent Application Publication
(10) Pub. No.: US 2015/0232077 A1
(43) Pub. Date: Aug. 20, 2015

(54) PIVOTING AIR CHAMBER FOR BRAKING SYSTEM

(71) Applicant: TSE Brakes, Inc., Cullman, AL (US)

(72) Inventor: Carl Gaufin, Hancerville, AL (US)

(21) Appl. No.: 14/625,037

(22) Filed: Feb. 18, 2015

Related U.S. Application Data
(60) Provisional application No. 61/939,983, filed on Feb. 14, 2014.

(51) Int. Cl. B60T 13/38; B60T 13/40

(52) U.S. Cl. CPC B60T 13/38; B60T 13/40

(57) ABSTRACT

A pivoting air chamber for a vehicle braking system includes a mounting bracket adapted to be attached to the vehicle. The air chamber includes an air chamber housing that is pivotally mounted to the mounting bracket. An actuator rod that is adapted to be attached to the vehicle braking system may be actuated so as to extend from and retract into the air chamber housing. The air chamber pivots with respect to the bracket, and thus the vehicle, when the actuator rod extends from or is retracted into the air chamber housing.

### CROSS REFERENCE TO RELATED APPLICATIONS

This application claims priority to U.S. Provisional Patent Application No. 61/939,983, filed Feb. 14, 2014, the entire contents of which are hereby incorporated by reference.

### FIELD OF THE INVENTION

The present invention relates generally to air brake systems for vehicles and, in particular, to a pivoting air chamber for such a system.

### BACKGROUND

Heavy trucks, trailers and other commercial vehicles typically use an air brake system to provide the braking forces necessary to stop the vehicle. Such a system typically includes a brake pedal positioned on the floor of the driver's cab or compartment of the vehicle that, upon actuation, provides air from an air reservoir to an air chamber, indicated at 20 in FIG. 1. The air chamber acts as a pneumatic actuator in that it features an actuator rod 22 that either extends out of or retracts into the air chamber so as to activate the mechanism that pushes the brake lining material of the brake shoes against the vehicle brake drum 23 at each vehicle wheel-end. The mechanism typically includes a slack adjustor 24 which turns a cam roller via a camshaft 26 so as to force the brake shoes to engage the brake drum so as to stop the vehicle.

With reference to FIG. 1, air chambers 20 are typically bolted to a bracket 30 that has been welded onto the axle 32 of a vehicle. While such an approach is seemingly simple, there are a number of disadvantages. There are varying torque requirements for the bolts that hold the air chambers to the brackets, and pneumatic tools are needed for the installation. Lock washers are typically required as are special bolt head designs to minimize failure. Furthermore, there are varying thread pitches and housing gages that must be contended with and there often is difficulty in removing the air chamber due to corrosion. In addition, as explained in greater detail below, there is an additional bending moment that occurs at the joint where the air chamber is secured to the bracket.

A need exists for an air chamber mounting arrangement that addresses at least some of the above issues

### BRIEF DESCRIPTION OF THE DRAWINGS

FIG. 1 is a perspective view of a prior art braking system air chamber mounted on a vehicle axle;

FIG. 2 is a schematic side elevational view of the prior art braking system air chamber of FIG. 1;

FIG. 3 is a schematic side elevational view of an embodiment of the pivoting air chamber of the present invention;

FIG. 4 is a front elevational view of a prior art air chamber mounting bracket;

FIG. 5 is a front elevational view of an embodiment of the air chamber mounting bracket of the present invention;

FIG. 6 is a perspective view of an embodiment of the pivoting air chamber and an adapter bracket of the present invention;

FIG. 7 is a front elevational view of the adapter bracket of FIG. 6;

FIGS. 8A and 8B are side elevational views of the pivoting air chamber of FIG. 6 with the actuator rod retracted and extended, respectively;

FIGS. 9A and 9B are one quarter cutaway views of an embodiment of the pivoting air chamber of the invention with the actuator rod in the retracted and extended positions, respectively;

FIG. 10 is a one quarter cutaway view of an alternative embodiment of the pivoting air chamber of the present invention having an external emergency spring;

FIG. 11 illustrates a stroke indicator in an embodiment of the pivoting air chamber of the present invention.

### DETAILED DESCRIPTION OF EMBODIMENTS

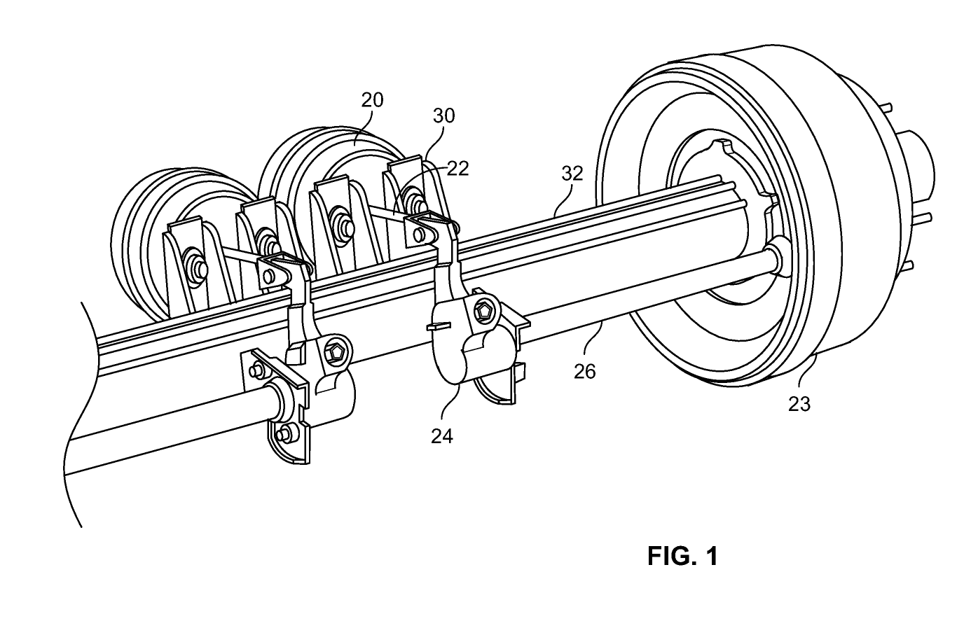

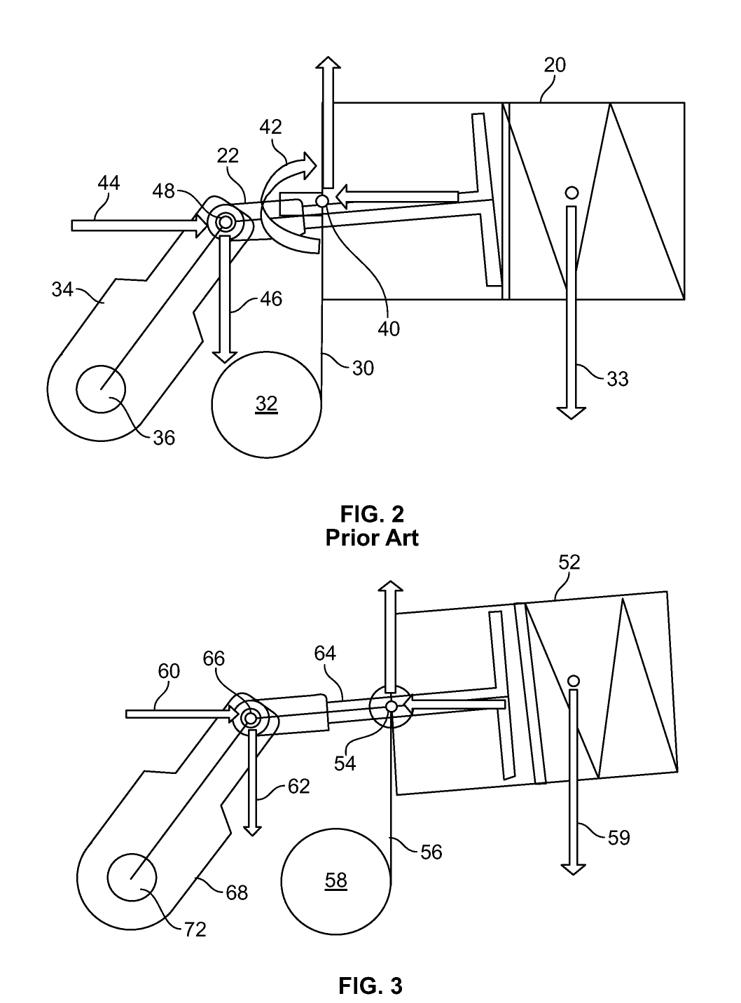

A prior art air chamber for a braking system is indicated at 20 in FIG. 2. As described previously, the air chamber 20 is mounted to a vehicle axle 32 by way of a bracket 30. The force from the center of gravity of the air chamber 20 is indicated by arrow 33. When the vehicle brakes are applied, such as by the driver pushing the brake pedal in the vehicle cab, the actuator rod 22 extends from the air chamber 20 so that the lever 34 of the slack adjuster pivots counter-clockwise about shaft 36 and actuates the slack adjustor (24 in FIG. 1). When the vehicle brake pedal is released, the actuator rod 22 is retracted into the air chamber 20 and the lever 34 is pivoted in the clockwise direction. Because the air cylinder 20 is secured to the mounting bracket 30 in a fixed fashion, during extension of the actuator rod 22 from the air chamber, the bolts or studs 40 securing the air chamber to the mounting bracket are subject to the moment indicated by arrow 42 as horizontal and vertical forces 44 and 46 act on the clevis pin 48 joining the actuator rod 22 and slack adjustor lever 34.

With reference to FIG. 3, and in accordance with the present invention, an air chamber or cylinder 52 is secured to a mounting bracket 56 by way of a pivoting connection 54. The mounting bracket 56 is welded or otherwise attached to a vehicle axle 58. The force from the center of gravity of the air chamber 52 is indicated by arrow 59. The mounting bracket may alternatively be connected to the vehicle other than by the axle including by, but not limited to, the vehicle frame or suspension components. Furthermore, the bracket may alternatively be a trunion, pivot bracket or clevis bracket. Due to pivoting connection 54, the air chamber 52 is free to pivot in response to the horizontal and vertical forces 60 and 62 acting on the distal end of actuator rod 64 by clevis pin 66 when the actuator rod is extended out of or retracted into the air chamber 52 and the slack adjustor lever 68 is pivoted about shaft 72. As a result, any moment at the mounting point(s) of the air chamber to the mounting bracket are eliminated or minimized. This results in less stress at the joint between the air chamber and the mounting bracket.

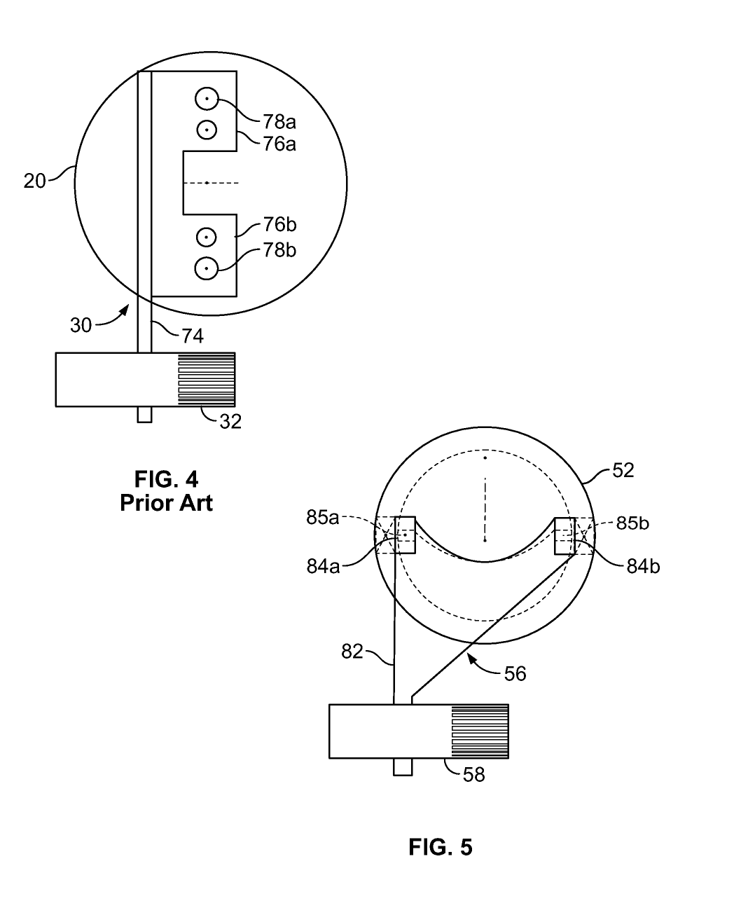

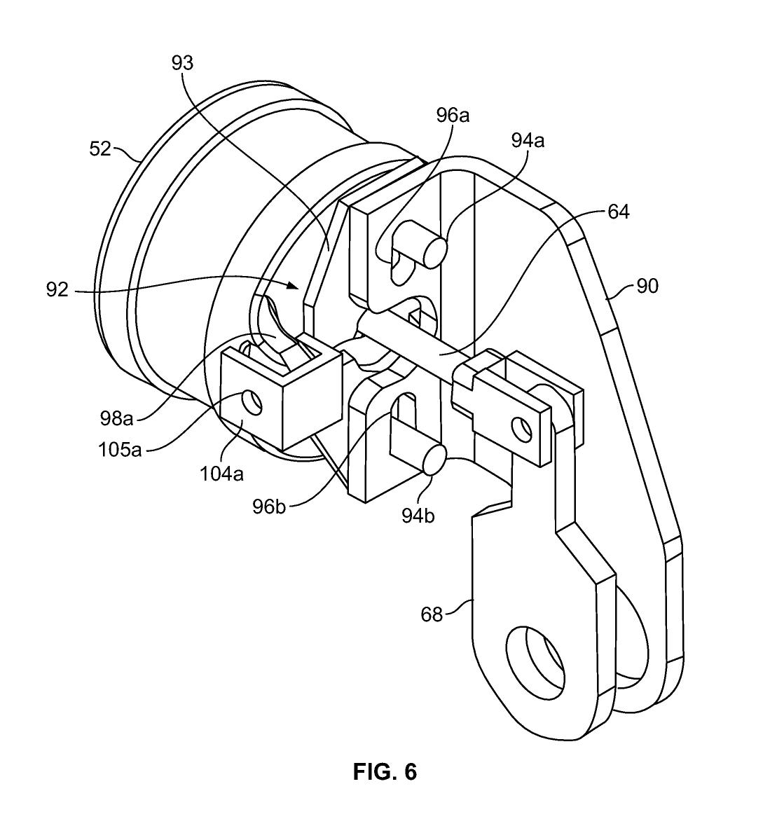

A comparison of the prior art “fixed mount” bracket 30 and the mounting bracket 56 in an embodiment of the invention is presented in FIGS. 4 and 5. As illustrated in FIG. 4, the prior art mounting bracket, indicated in general at 30, features a support web 74 that is attached to the axle 32 and upon which is provided a mounting plate having tabs 76a and 76b which features fastening apertures 78a and 78b. The fastening apertures receive the bolts or studs for attaching the air chamber to the mounting bracket.

In contrast, as illustrated in FIG. 5, mounting bracket 56 includes a support web 82 that is attached to the axle 58 (or alternatively elsewhere on the vehicle). A pair of spaced ears 84a and 84b having fastener openings are provided on the mounting bracket and, as explained in greater detail below, are pivotally attached to the air chamber.

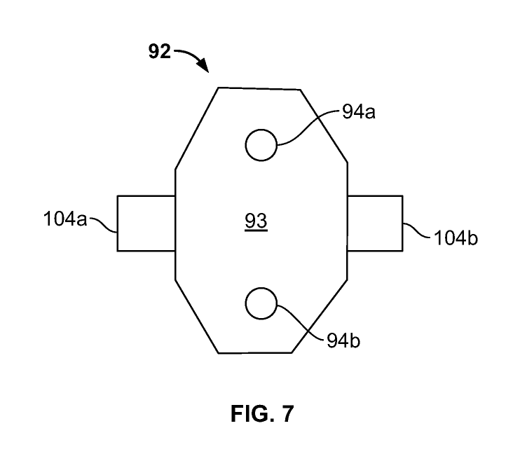

With reference to FIGS. 6 and 7, a prior art mounting bracket 90 may be modified via an adapter bracket, indicated in general at 92, to enable an air chamber 52 to be pivotally mounted to a vehicle. More specifically, the adapter bracket 92 features a pair of studs or bolts 94a and 94b that are mounted to a central plate 93 and received and secured within the mounting slots 96a and 96b of the prior art mounting bracket 90, such as by nuts or welding. In addition, the adapter bracket 92 features a pair of pivot mounting ears 104a and 104b positioned on opposite sides of the central plate 93.

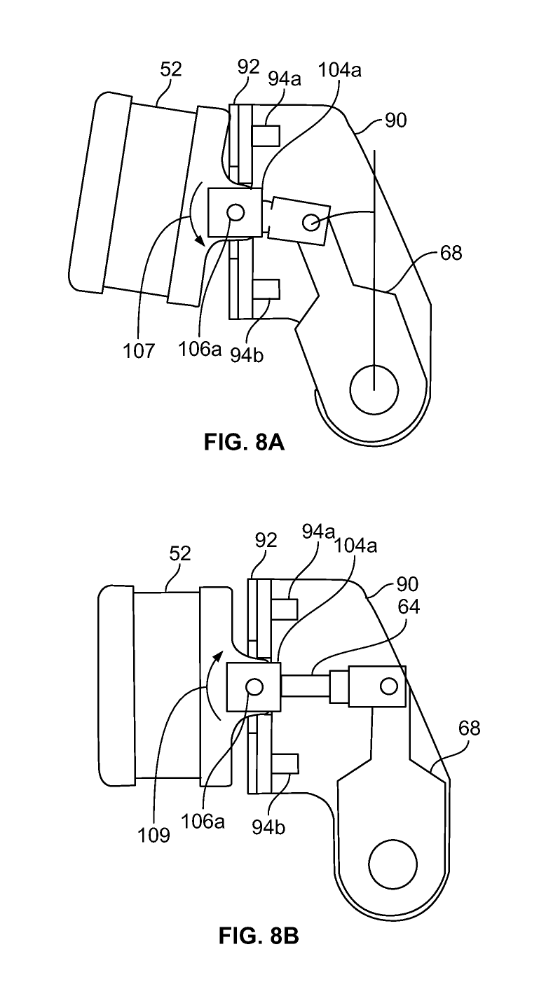

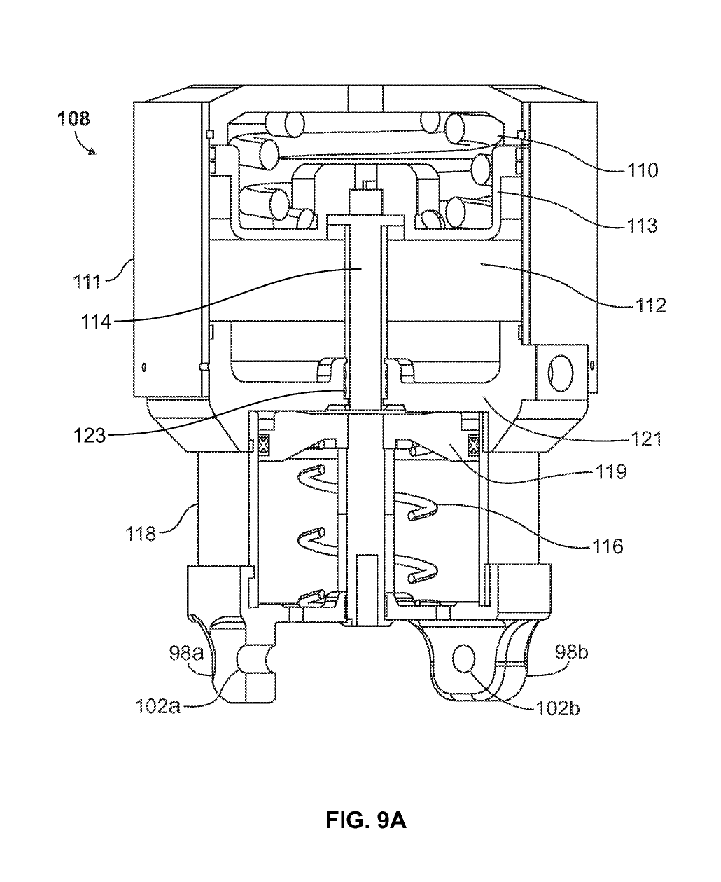

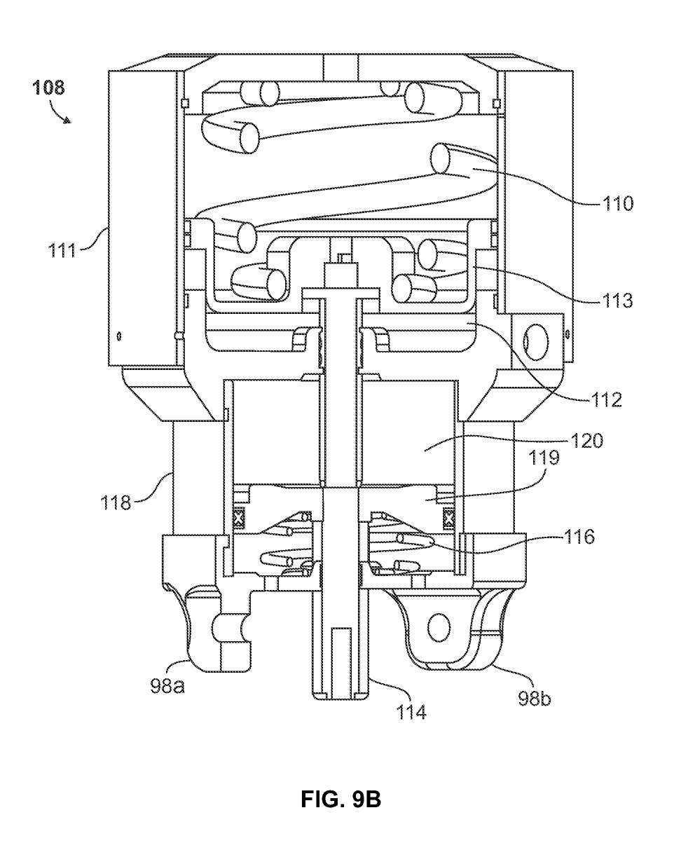

The air chamber 52 includes a pair of mounting tabs 98a and 98b which feature openings 102a and 102b (illustrated in FIGS. 9A and 9B). The air chamber mounting tabs 98a and 98b are positioned within the pivot mounting ears 104a and 104b of the adapter bracket 92, as illustrated in FIG. 6A, or adjacent to ears 84a and 84b of FIG. 5, and secured in place in a pivoting fashion with pins and cotter pins 106a and 106b (FIGS. 8A and 8B) that pass through openings 102a and 102b (FIG. 9A) of the air chamber mounting tabs 98a and 98b and the corresponding openings of ears 84a and 84b (indicated in phantom at 85a and 85b of FIGS. 5) or 104a and 104b (indicated at 105a for ear 104a in FIG. 6).

Articulation of the pivoting air chamber and slack adjustor lever of FIG. 6 is illustrated in FIGS. 8A and 8B. The position of the air chamber 52 adjusts to be aligned with the actuator rod 64 as it is extended out of and retracted into the air chamber 52. More specifically, the actuator rod 64 is illustrated in FIG. 8A in a position where it is fully retracted within the air chamber 52. This corresponds to the vehicle brakes not applied. When in such a position, the actuator rod is at an angle with respect to horizontal. As a result, the air chamber 52 has been tilted slightly. As the vehicle brakes are applied, the actuator rod 64 extends out of the air chamber 52 into the position illustrated in in FIG. 8B where it is generally horizontal. As a result, the air chamber pivots counterclockwise about pins 106a and 106b (not shown), as indicated by arrow 107 of FIG. 8A, so that it is aligned with the extended actuator rod. When the vehicle brakes are released, and the actuator rod 64 one again retracts back into the air chamber 52, the air chamber 52 rotates in the clockwise direction about pins 106a and 106b, as indicated by arrow 109 of FIG. 8B, back into the tilted position illustrated in FIG. 8A.

An embodiment of the air chamber of the invention is indicated in general at 108 in FIGS. 9A and 9B. A large main compression spring 110 (also known as an emergency spring, a parking spring or a power spring) is positioned within an upper housing 111 and serves as a mechanical means to prevent the vehicle from rolling when there is no air in the brake system, and thus no air in upper cavity 112, and when the vehicle is stationary or parked. This situation is illustrated in FIG. 8B, where the emergency spring 110 is shown as supplying the parking force needed to hold the vehicle stationary via piston 113 pushing actuator rod 114 so that the actuator rod is extending out of the air chamber.

A service compression spring 116 is positioned within a lower housing 118 of the air chamber and urges a piston 119 and the actuator rod 114 in a direction whereby it retracts into the lower housing of air chamber 108, as illustrated in FIG. 9A. In other words, FIG. 9A illustrates the situation where there is air supplied to the air brake system, and thus to air chamber 108, but the vehicle brakes have not been applied by the operator of the vehicle. When the vehicle operator applies the brakes, such as by pressing on the brake pedal in the vehicle cab, lower cavity 120 (FIG. 9B) fills with air and forces piston 119 downwards so that the actuator rod 114 extends from the air chamber so as to actuate the slack adjustor and apply the vehicle brakes.

The upper cavity 112 of the air chamber 108 is separated from the lower cavity by a separator plate 121 having a central opening through which the actuator rod 114 passes. The separator plate 121 central opening is provided with a seal 123. As a result, the air chamber 108 of FIGS. 9A and 9B does not require a diaphragm, and therefore the housing of the air chamber does not require the associated circumferential bead. This enables the air chambers in embodiments of the invention to have a smaller outer diameter than prior art air chambers, as illustrated by a comparison of the air chamber 20 of FIG. 4 to the air chamber 52 of FIG. 5.

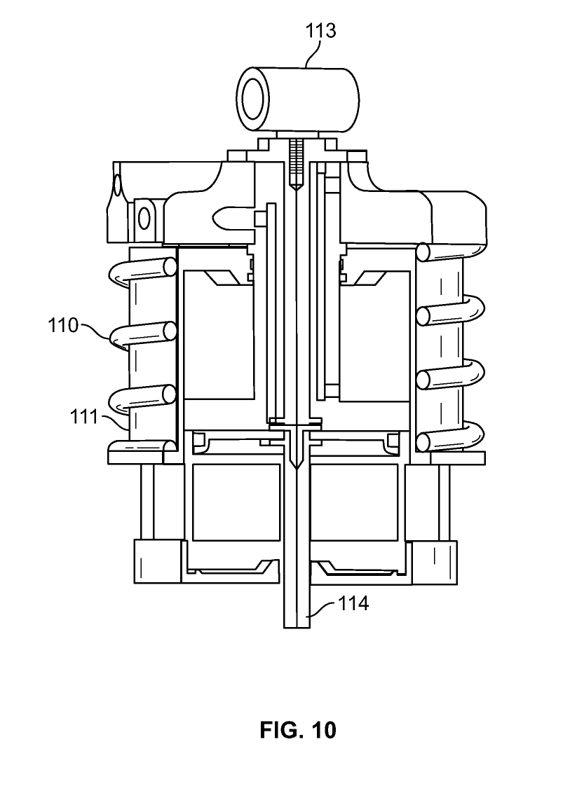

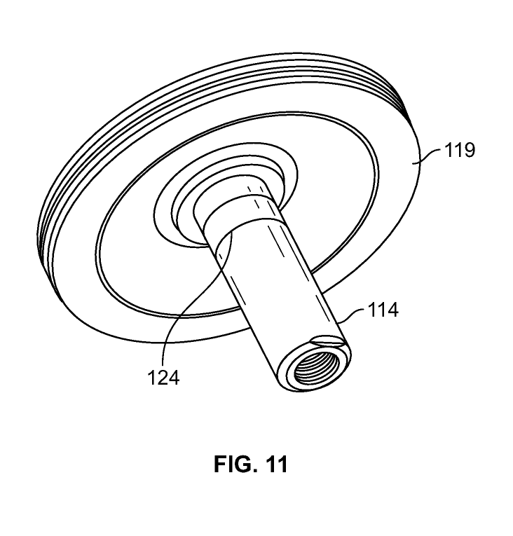

In an alternative embodiment of the air chamber, illustrated in FIG. 10, the smaller outer diameter of the air chamber housing permits the emergency spring 110 to be positioned exterior to the upper housing 111 of the air chamber. Furthermore, FIG. 10 illustrates that the top of the upper housing or body 111 of the air chamber may be adapted for the pivotal connection via top mounting cylinder 113 (instead of air chamber mounting tabs 98a and 98b of FIGS. 9A and 9B). Other locations on the body of the air chamber may alternatively be used for the pivotal connection to a mounting bracket may be used.

By eliminating (or drastically reducing) the bending moment acting on the actuator rod, embodiments of the present invention permit aluminum actuator rods to be used. Steel is typically used in prior art actuator rods, because steel has a much higher stiffness than aluminum. By pivoting the air chamber so as to line up the rod actuation forces in accordance with embodiments of the present invention, less bending strength is required for the actuator rod so that aluminum may be used. With reference to FIG. 11, this permits an anodized color stripe 124 to be provided as a stroke indicator on the actuator rod 114. This is more durable and cleaner than the prior art painted or “sticker” stroke indicators and eliminates the mess associated with applying the painted or sticker markers. Furthermore, embodiments of the present invention keep the actuator rod clean, which facilitates viewing of the stroke indicator anodized stripe. The aluminum material provides a weight savings as well.

The embodiments of the pivoting air chamber described above offer numerous advantages over the prior art. These include no (or minimal) moment about the mounting studs to reduce vibration damage, efficient quick and easy installation and removal, lighter weight, a smaller package for air chamber, a more reliable force output (especially useful for computerized braking systems), a larger force in a smaller air chamber envelope and the possibility of internal or external emergency spring placement.

While the preferred embodiments of the invention have been shown and described, it will be apparent to those skilled in the art that changes and modifications may be made therein without departing from the spirit of the invention, the scope of which is defined by the following claims.

What is claimed is:

1. A pivoting air chamber for a vehicle braking system comprising:
a. a mounting bracket adapted to be attached to the vehicle;
b. an air chamber housing pivotally mounted to the mounting bracket;
c. an actuator rod adapted to be connected to the vehicle braking system and that extends from and retracts into the air chamber housing when the actuator rod is actuated; and
d. said air chamber housing pivoting with respect to the mounting bracket when the actuator rod is actuated.

2. The pivoting air chamber of claim 1 wherein the mounting bracket includes a pair of pivot mounting ears and the air chamber includes a pair of mounting tabs that are pivotally joined to the pair of pivot mounting ears.

3. The pivoting air chamber of claim 1 wherein the air chamber includes an emergency spring urging the actuator rod towards extending from the air chamber and a service spring that urges the actuator rod towards retracting into the air chamber.

4. The pivoting air chamber of claim 3 wherein the air chamber includes a housing, and the emergency spring is positioned within the housing.

5. The pivoting air chamber of claim 3 wherein the air chamber includes a housing and the emergency spring is positioned external to the housing.

6. The pivoting air chamber of claim 1 wherein the actuator rod is constructed from aluminum.

7. The pivoting air chamber of claim 6 wherein the actuator rod includes an anodized stroke indicator.

8. The pivoting air chamber of claim 7 wherein the anodized stroke indicator is a color stripe.

9. The pivoting air chamber of claim 1 wherein the mounting bracket includes an adapter bracket adapted to attach to a vehicle-mounted bracket.

10. The pivoting air chamber of claim 1 wherein the actuator rod is adapted to attach to a slack adjuster of the vehicle braking system.

11. The pivoting air chamber of claim 1 wherein the mounting bracket is adapted to be mounted to the axle of the vehicle.

12. An air chamber for a braking system comprising:
a. a housing;
b. an actuator rod adapted to be connected to the braking system and that extends from and retracts into the air chamber housing when actuated;
c. said housing adapted to be mounted to a bracket so that the air chamber pivots with respect to the bracket.

13. The air chamber of claim 12 further comprising a pair of mounting tabs attached to the housing, said mounting tabs adapted to be pivotally mounted to the bracket.

14. The air chamber of claim 13 wherein each of the pair of mounting tabs includes a mounting hole.

15. The air chamber of claim 12 further comprising a mounting cylinder attached to the housing, said mounting cylinder adapted to be pivotally mounted to the bracket.

16. The air chamber of claim 12 wherein the air chamber includes an emergency spring urging the actuator rod towards extending from the air chamber and a service spring that urges the actuator rod towards retracting into the air chamber.

17. The air chamber of claim 16 wherein the air chamber includes a housing, and the emergency spring is positioned within the housing.

18. The air chamber of claim 16 wherein the air chamber includes a housing and the emergency spring is positioned external to the housing.

19. The pivoting air chamber of claim 12 wherein the actuator rod is constructed from aluminum and includes an anodized stroke indicator that is a color stripe.

20. A method for mounting an air chamber for a braking mechanism to a vehicle, where the air chamber has an actuator rod that is actuated to extend from and retract into the air chamber, comprising the steps of:
a. mounting a bracket to a vehicle;
b. pivotally mounting the air chamber to the mounting bracket; and
c. attaching the actuator rod of the air chamber to the braking mechanism of the vehicle.
